(19) United States
(12) Patent Application Publication
(10) Pub. No.: US 2021/0160059 A1
(43) Pub. Date: May 27, 2021

(54) DATA PROCESSING DEVICE FOR PROCESSING A RADIO SIGNAL

(71) Applicant: Siemens Aktiengesellschaft, München (DE)

(72) Inventor: Rainer Falk, Poing (DE)

(21) Appl. No.: 17/047,444

(22) PCT Filed: Apr. 12, 2019
(86) PCT No.: PCT/EP2019/059406

§ 371 Date: Oct. 14, 2020

(30) Foreign Application Priority Data
Apr. 25, 2018 (EP) 18169252.6

(51) Int. Cl. H04L 9/06; H04L 9/32; H04W 4/029; G06F 16/13

(52) U.S. Cl. CPC H04L 9/0643; H04L 9/3239; H04L 2209/38; G06F 16/137; H04W 4/029

(57) ABSTRACT

A data processing device, which is adapted to process a first radio signal is provided. Hereby, the data processing device includes a receiver unit, which is adapted to receive the first radio signal, wherein the first radio signal is indicative of a first set of positions of an object within a first time interval. The data processing device further includes a transaction data generation unit, which is adapted to generate first transaction data based on the received first radio signal. The data processing device further includes an output unit, which is adapted to transfer the first transaction data to the distributed database. Further provided is a corresponding method of processing a first radio signal.

### CROSS-REFERENCE TO RELATED APPLICATIONS

This application claims priority to PCT Application No. PCT/EP2019/059406, having a filing date of Apr. 12, 2019, which is based on EP Application No. 18169252.6, having a filing date of Apr. 25, 2018, the entire contents both of which are hereby incorporated by reference.

### FIELD OF TECHNOLOGY

Various embodiments of the invention enable techniques for processing radio signals into transaction data, which may be transferred to a distributed database.

### BACKGROUND

Satellite navigation systems, such as the Global Positioning System (GPS), have already been established exhaustively in the present economic and private life. By way of example, these techniques have been used for tracking industrial products, piloting air transportation and preventing criminal acts.

However, preventing manipulation of such satellite navigation systems, commonly based on radio signaling comprising positional information of an object, is a major issue, since successfully completed manipulation means may obscure criminal activities, increase the occurrence of traffic accidents and degrade logistic efficiencies.

Therefore, there is a demand to improve the protection against manipulation of radio signals comprising positional information of an object.

Apart from this, documents U.S. Pat. No. 8,531,247 B2, U.S. Pat. No. 8,892,616 B2, U.S. Pat. No. 8,300,811 B2, U.S. Pat. No. 9,147,088 B2, U.S. Pat. No. 9,584,311 B2, EP 2976707 B1, EP 2 605 445 B1, EP 2 870 565 A1, EP 2 891 102 A1, WO 2017137256 A1, EP 2870565 B1, EP 3028140 B1, EP 17175275 and U.S. Pat. No. 8,843,761 B2 are known to a skilled person.

### SUMMARY

An aspect relates to improving data protection against manipulation of radio signals comprising positional information of an object.

According to an embodiment, a data processing device is disclosed, which is adapted to process a first radio signal. The data processing device comprises a receiver unit, which is adapted to receive the first radio signal, wherein the first radio signal is indicative of a first set of positions of an object within a first time interval. The data processing device further comprises a transaction data generation unit, which is adapted to generate first transaction data based on the received first radio signal. The data processing device further comprises an output unit, which is adapted to transfer the first transaction data to the distributed database.

Such an approach is based on the finding that protection against manipulation of the first radio signal may be improved by converting these signals into a form, based on which the positional information of the object contained in the first radio signal may be distributed to a plurality of different means for data storage. In such a case, a potential manipulator would have to manipulate a plurality of different network nodes containing the respective storage means, which may be arranged globally. In doing so, protection against manipulation of the first radio signal may be improved. In addition, the adaption of the receiver unit to receive the radio signal, which is based on positions of the object within a certain time interval, enables saving of a high amount of object information by a efficient processing procedure, which is based on an adaption for successively processing corresponding entities of radio signals.

According to another embodiment, a method of processing a first radio signal is disclosed. The method comprises

receiving the first radio signal, wherein the first radio signal is indicative of a first set of positions of an object within a first time interval. The method further comprises generating transaction data based on the received first radio signal. The method further comprises transferring the transaction data to the distributed database.

Such an approach makes use of the advantages of the device outlined above.

A radio signal within the meaning of the present disclosure may refer to any data sequence provided in a manner, which is at least partly based on electromagnetic waves in a radio frequency range. The radio signal may be indicative of a set of positions of an object within a certain time interval. Different radio signals of the same object may be established at different time intervals. Such different radio signals may refer to the first radio signal and/or the second radio signal and/or the third radio signal disclosed herein. Each radio signal may further be configured as a radio snippet. Each radio signal may further be configured as a digital radio signal. At least one digital radio signal may be encoded as a time-discrete sequence of value-discrete signal values (e.g. 8 bit, 12 bit, 16 bit).

A time interval within the meaning of the present disclosure may refer to any window in time having a starting point and a final point. Within such a time interval, a plurality of events may occur at different points in time. Each of these events may be associated with the present position of an object. Different time intervals may be associated with the same object and may be different from each other. Such different time intervals may comprise the first time interval and/or the second time interval and/or the third time interval disclosed herein. At least one time interval may comprise a duration in the range of 1 μs-10 ms and/or may be associated with a data volume in the range of 1 kB-100 kB. The duration of the respective time intervals may be identical or different. The time intervals may have an overlapping region or may have no overlapping region.

Transaction data within the meaning of the present disclosure may refer to any data amount, which may be handled commonly within any kind of transaction. Such a transaction may refer to a data transfer to a distributed database. Different transaction data may refer to different radio signals. As an example, first transaction data may correspond to a first radio signal, second transaction data may correspond to a second radio signal and third transaction data may correspond to a third radio signal. It may further be provided that each transaction data is based on one radio signals. It may further be provided that each transaction data is based on several radio signals. It may further be provided that each transaction data is based on the same amount of radio signals. The transaction may further correspond to a transaction within a Blockchain environment, in which the distributed database is a Blockchain based database. In a Blockchain environment, a transaction may refer to an operation for adding data to the Blockchain based database, wherein such a transaction is to be verified by any network node of the Blockchain based database. Such a Blockchain based database within the meaning of the present disclosure may also be denominated as a distributed ledger.

A distributed database within the meaning of the present disclosure may refer to an entity in which means for storing are distributed to different processing means and/or to different locations. Hereby, the distributed database may refer to a Blockchain based database and to a distributed ledger, respectively.

In an embodiment, the data processing device further comprises an encryption unit, which is adapted to encrypt the first transaction data and to provide a corresponding transaction data key, wherein the output unit is further adapted to transfer the transaction data key to the distributed database.

Thereby, the data processing device is adapted to further improve protection against manipulation, since it may provide first transaction data in an encrypted mode, which confuses the issue of manipulating the first transaction by a manipulator.

In another embodiment, the output unit is adapted to transfer the transaction data key to the distributed database after the corresponding encrypted first transaction data has been transferred to the distribution database.

Using these means, the data processing device may ensure that the decoded first transaction data transferred to the distributed data base may only be evaluated by a participant of the distributed database in a time-delayed manner. Thus, an information advantage of devices directly connected with the data processing device compared to devices receiving the respective transaction data via the distributed database may be achieved, which consequently results in a hierarchical network architecture.

In another embodiment, the data processing device further comprises a hash value generation unit, which is adapted to generate a hash value of the first transaction data comprising a reduced data size, wherein the output unit is further adapted to transfer the hash value to the distributed database. In another embodiment, the output unit is adapted to transfer the first transaction data to the distributed database after the corresponding hash value has been transferred to the distributed database.

Thereby, a unique fingerprint of the first transaction data comprising a reduced data volume may additionally be provided. Based on the reduced value of the hash value compared to the respective first transaction data, the hash value may be generated and transferred to the distributed database at an earlier point of time. Therefore, the hash value may preliminary be provided to the distributed databased as a substituent. As an example, such an approach may be used in order to disclose the distributed database community at an early point of time that the first radio signal has already been received by the data processing device, wherein the corresponding information of the first radio signal may be shared with the distributed database community at a later point in time or may use different data transmission means. Such an approach may result in an information advantage of devices directly connected with the data processing device compared to devices participating in the distributed database. According to another example, the hash values transferred to the distributed database may provide for preliminary protection against manipulation, since it uniquely indicates that the first radio signal has already been received by the data processing device. Although the distributed hash value does not comprise the entire information of the first radio signal, it may indicate, whether the first radio signal received by the data processing device has been erased by an manipulator.

In another embodiment of the device, the output unit is adapted to transfer the first transaction data to the distributed database using wireless mobile communication.

Thereby, the device enables a fast and efficient transfer of the first transaction data to the distributed database, even if the distributed database comprises far-flunged network nodes. In addition, such an adaption enables to transfer the first transaction data to different network nodes of the distributed database at the same time.

In another embodiment, the first transaction data comprise first information related to a serial number of the data processing device and/or PVT (position, velocity, time) information determined by the data processing device.

Thereby, additional information related to the specific processing device providing the first transaction data may be distributed to the distributed database. Thus, in case that the distributed database may determine irregularities with respect to any received first transaction data, these irregularities may be allocated to a specific data processing device, which may then reviewed, if such a data processing device is affected by any kind of manipulating means.

In another embodiment, the first transaction data comprise second information indicative of at least one further property of the object, wherein the at least one further property relates to temperature, pressure, brightness data, image information, video information, radar information and lidar information.

Thereby, the data processing device is adapted to supplement the generated first transaction data using additional information of the objected to be investigated. Thus, monitoring of the object under investigation may be improved.

In another embodiment, the distributed database is a Blockchain based database.

Since such a Blockchain based database provides for additional cryptographic means for securing data transactions in a respective Blockchain, such means further improve the protection of radio signals against manipulation.

In another embodiment, the first transaction data comprise a Smart Contract program code.

Since such a Smart Contract program code may comprise information regarding the admissibility of including such first transaction data in the distributed database, depositing of transaction data in the distributed database may be realized in a more controlled and user-determined manner.

In an embodiment, the data processing device is further adapted to process a second radio signal indicative of a second set of positions of the object within a second time interval, wherein the transaction data generation unit is further adapted to generate second transaction data based on the received second radio signal, and wherein the output unit is adapted to transfer the first transaction data and the second transaction data separately to the distributed database.

Thereby, the data processing device is adapted to provide the distributed database with time-resolved information of the object. Due to the adaption for successive processing of the first and second radio signal, the data processing device, which enables uploading of data to the distributed database, hereby provides for an efficient data handling.

In another embodiment, the first radio signal and the second radio signal comprise the same data volume size and/or the same time interval length.

Thereby, the efficiency of processing radio signals by the data processing device may be further improved.

In another embodiment, the data processing device is further adapted to process a second radio signal indicative of a second set of positions of the object within a second time interval, wherein the first time interval and the second time interval do not comprise an overlap region.

Using these means, it is prevented to include the same positional information of the object within the first radio signal and the second radio signal. Consequently, the data processing device is adapted to transfer the same amount of positional data of the object to the distributed database, while at the same time having less processing effort. Therefore, efficiency of the data processing device may be further improved.

In another embodiment, the data processing device is further adapted to process a third radio signal indicative of a third set of positions of the object within a third time interval, wherein the distance in between the starting point of the first time interval and the second time interval is equal to the distance in between the starting point of the second time interval and the third time interval.

Thereby, the time-resolved monitoring of the object under investigation may be performed in a equable manner. In doing so, monitoring control of the object under investigation may be improved.

In another embodiment, the first radio signal is based on a satellite navigation service.

Thereby, the first radio signal comprises positional information of the object, which represents the effective performance of the object, such as the effective time-resolved location of the object, in a more precise manner.

In another embodiment, a transaction data receiving device is disclosed, which is adapted to be in communication with the data processing device according to the present disclosure, and which is adapted to receive the transaction data of the data processing device in case that the transaction data receiving device forms an integral part of the distributed database.

Thereby, a network node may be implemented by a participant of the distributed database, which may receive positional information of the object under investigation via the distributed database.

In an embodiment, the method is executed by a data processing device according to the present disclosure.

Thereby, the method can be executed according to the respective user demand.

A transaction data key within the meaning of the present disclosure may refer to any technical means, based on which transaction data may at least partly be encrypted. Such transaction data may refer to at least one of first transaction data, second transaction data and third transaction data.

A hash value within the meaning of the present disclosure may refer to any checksum characteristic for a certain data amount. Hereby, the certain data amount may comprise at least one of the first transaction data and the second transaction data. The hash value of each data amount may be unique. The hash value may be determined using any cryptographic means for encrypting. The hash value may also be determined using any cryptographic calculation means.

A Smart Contract program code within the meaning of the present disclosure may refer to any IT protocol, which is adapted to control a transfer of any transaction data to the distributed database. Hereby, the transaction data may comprise at least one of the first transaction data and the second transaction data.

A satellite navigation service within the meaning of the present disclosure may refer to any technical service, which is adapted to provide means for autonomous geo-spatial positioning based on satellite signaling. The satellite navigation service may refer to at least one of GPS, Galileo Open Service, Galileo Commercial Service, Galileo Public Regulated Service, Glonass and Beidou.

The above summary is merely intended to give a short overview over some features of some embodiments and implementations and is not to be construed as limiting. Other embodiments may comprise other features than the ones explained above.

### BRIEF DESCRIPTION

Some of the embodiments will be described in detail, with reference to the following figures, wherein like designations denote like members, wherein:

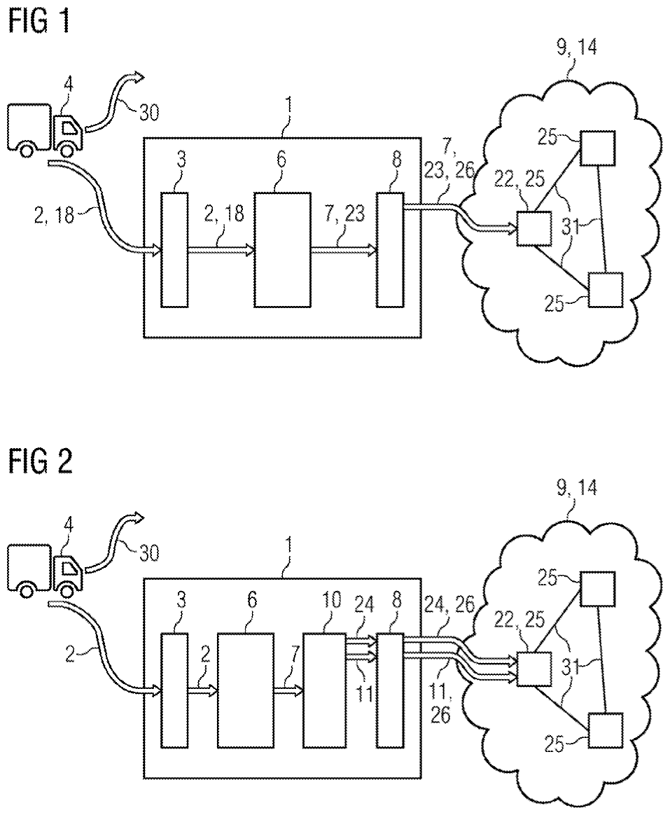

FIG. 1 schematically illustrates an environment of a data processing device, which is adapted to process a first radio signal and a second radio signal, according to embodiments of the present invention;

FIG. 2 schematically illustrates another environment of a data processing device, which is adapted to process a first radio signal, according to embodiments of the present invention;

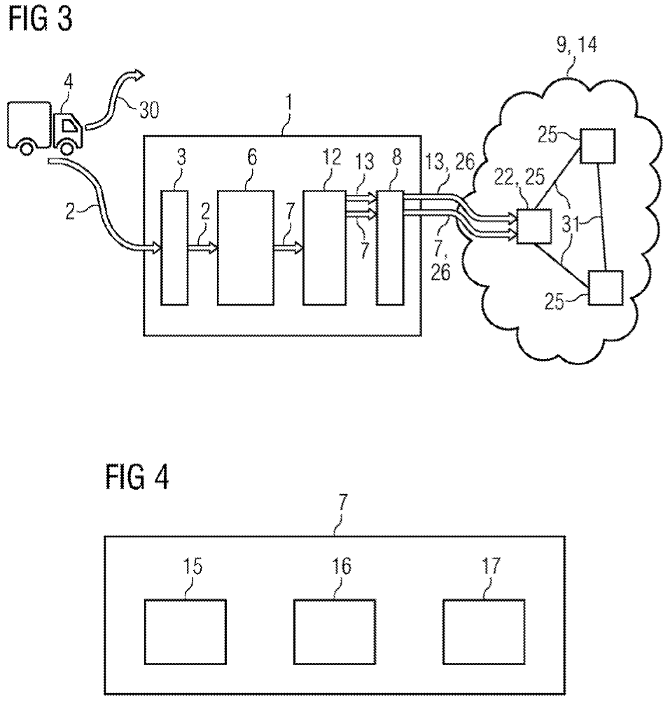

FIG. 3 schematically illustrates another environment of a data processing device, which is adapted to process a first radio signal, according to embodiments of the present invention;

FIG. 4 schematically illustrates a first transaction data according to embodiments of the present invention;

FIG. 5 schematically illustrates a diagram depicting a first radio signal, which can be extracted from a radio basic signal;

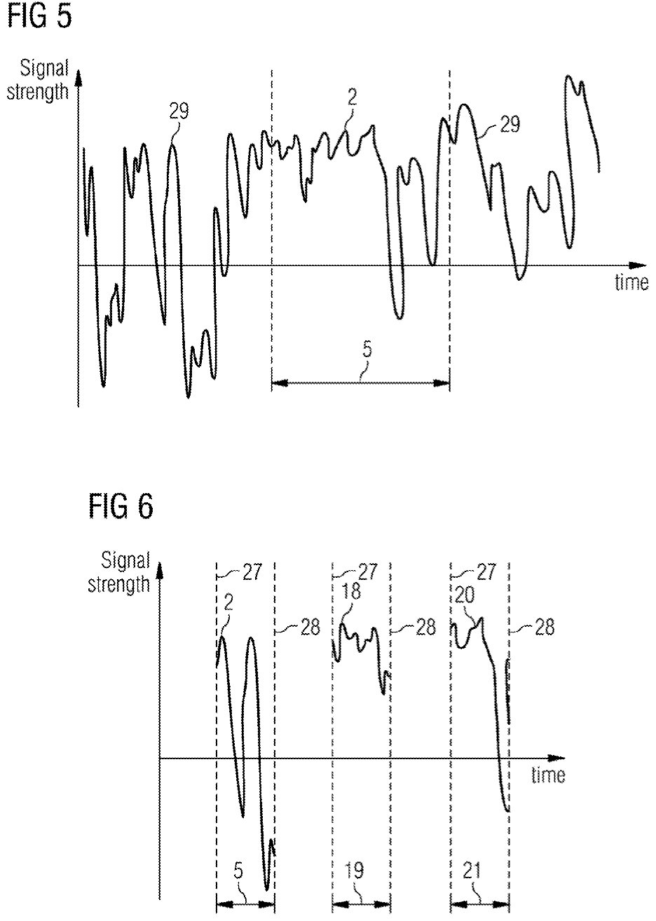

FIG. 6 schematically illustrates a diagram depicting different radio signals, which can be extracted from a radio basic signal; and

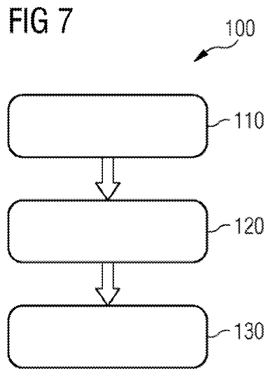

FIG. 7 schematically illustrates a flowchart of a method of processing a first radio signal according to embodiments of the present invention.

### DETAILED DESCRIPTION

In the following, embodiments of the invention will be described in detail with reference to the accompanying drawings. It is to be understood that the following description of embodiments is not to be taken in a limiting sense. The scope of embodiments of the invention are not intended to be limited by the embodiments described hereinafter or by the drawings, which are taken to be illustrative only.

The drawings are to be regarded as being schematic representations and elements illustrated in the drawings, which are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

FIG. 1 schematically illustrates an environment of a data processing device 1, which is adapted to process a first radio signal 2 and a second radio signal 18, according to various examples.

Hereby, the data processing device 1 may comprise a receiver unit 3, which is adapted to receive the first radio signal 2, wherein the first radio signal 2 is indicative of a first set of positions of an object 4 within a first time interval 5. As an example, the first set of position may refer to time-resolved positional data of the object 4 moving along the object trajectory 30. The first radio signal 2 may be further based on a satellite navigation service, such as GPS, Galileo Open Service, Galileo Commercial Service or Galileo Public Regulated Service.

The data processing device 1 may be further configured to deliver the received first radio signal 2 to a transaction data generation unit 6. The transaction data generation unit 6, which may be further comprised by the data processing device 1, may be adapted to generate first transaction data 7 based on the received first radio signal 2. The data processing device 1 may be further configured to deliver the generated first transaction data 7 to an output unit 8. The output unit 8, which may be further comprised by the processing device 1, may be adapted to transfer the first transaction data 7 to a distributed database 9. Hereby, the output unit 8 may be adapted to transfer the first transaction data 7 to the distributed database 9 using wireless mobile communication signal 26, such as a 5G wireless mobile communication. According to this, the distributed database 9 may be a Blockchain based database 14.

In addition, the data processing device 1 may be further adapted to process a second radio signal 18 in a successive or parallel manner. Hereby, the receiver unit 3 may be further adapted to receive the second radio signal 18, which is indicative of a second set of positions of the object 4 within a second time interval 19. The receiver unit 3 may receive the first radio signal 2 and the second radio signal 18 in a successive manner. According to an example, the second set of positions may refer to time-resolved positional data of the object 4 moving along the object trajectory 30. The object 4, moving along the object trajectory 30, may pass the second set of positions, after the first set of positions has already been passed.

The data processing device 1 may be further configured to deliver the received second radio signal 18 to the transaction data generation unit 6. The transaction data generation unit 6 may be further adapted to generate second transaction data based 23 on the received second radio signal 18. The data processing device 1 may be further configured to deliver the generated second transaction data 23 to an output unit 8. The output unit 8 may be further adapted to transfer the second transaction data 23 to the distributed database 9. Hereby, the output unit 8 may be adapted to transfer the second transaction data 23 to the distributed database 9 using a wireless mobile communication signal 26, such as a 5G wireless mobile communication. The output unit 8 may be adapted to transfer the first transaction data 7 and the second transaction data 23 separately to the distributed database 9.

The distributed database 9 may comprise a plurality of network nodes 25 connected with each other by connections 31. According to an example, a network node 25 may be configured as a transaction data receiving device 22, which may adapted to be in communication with the data processing device 1 using the wireless data communication signal 26. The transaction data receiving device 22 may be configured to receive the first transaction data 7 and/or the second transaction data 23 of the data processing device 1.

FIG. 2 schematically illustrates another environment of a data processing device 1, which is adapted to process a first radio signal 2, according to various examples. For explanatory reasons, the data processing device 1 depicted in FIG. 2 is adapted to merely process a single radio signal, namely the first radio signal 2. However, it is also taken into consideration that the data processing device 1 according to FIG. 2 may be adapted to process a plurality of radio signals including the second radio signal 18 and the third radio signal 20.

The embodiment of the data processing device 1 according to FIG. 2 may be based on the embodiment according to FIG. 1 discussed above. Additionally, the data processing device 1 according to FIG. 2 may comprise an encryption unit 10, which may be adapted to encrypt the first transaction data 7 and to provide a corresponding data key 11, wherein the output unit 8 may be further adapted to transfer the transaction data key 11 to the distributed database 9. Hereby, the output unit 8 may be adapted to transfer the transaction data key 11 to the distributed database 9, after the corresponding encrypted first transaction data 24 has been transferred to the distributed database 9. According to an example, the encrypted first transaction data 24 and/or the transaction data key 11 may be adapted to be transferred to the distributed database 9 using a wireless data communication signal 26.

FIG. 3 schematically illustrates another environment of a data processing device 1, which is adapted to process a first radio signal 2, according to various examples. For explanatory reasons, the data processing device 1 depicted in FIG. 3 is adapted to process a single radio signal, namely the first radio signal 3. However, it is also taken into consideration that the data processing device 1 according to FIG. 3 may be adapted to process a plurality of radio signals including the second radio signal 18 and the third radio signal 20. In addition, it is also taken into consideration to combine the features according to the embodiments of FIGS. 2 and 3.

The embodiment of the data processing device 1 according to FIG. 3 may be based on the embodiment according to FIG. 1 discussed above. Additionally, the data processing device 1 according to FIG. 2 may comprise a hash value generation unit 12, which may be adapted to generate a hash value 13 of the first transaction data 7 comprising a reduced data size, wherein the output unit 8 is further adapted to transfer the hash value 13 to the distributed database 9. Hereby, the output unit 8 may be adapted to transfer the first transaction data 7 to the distributed database 9, after the corresponding hash value 13 has been transferred to the distributed database 9. According to an example, the hash value 13 and/or the corresponding first transaction data 7 may be adapted to be transferred to the distributed database 9 using a wireless data communication signal 26.

FIG. 4 schematically illustrates a first transaction data 7 according to various examples. It is also taken into consideration that the second radio signal 18 and/or the third radio signal 20 may be configured in the same or in a different manner.

According to this, the first transaction data 7 may comprise first information 15 related to a serial number of the data processing device 1 and/or PVT information determined by the data processing device. Further, the first transaction data 7 may comprise second information 16 indicative of at least one further property of the object 4, wherein the at least one further property relate to temperature, pressure, brightness data, image information, video information, radar information and lidar information. In addition, the first transaction data 7 may comprise a Smart Contract program code 17.

FIG. 5 schematically illustrates a diagram depicting a first radio signal 2, which can be extracted from a radio basic signal 29. Hereby, the first radio signal 2 to be extracted from the radio basic signal 29 may correspond to a first time interval 5 and the time-resolved signal strength of the first radio signal 2 may correspond to a first set of positions of the object 4. According to an example, the signal strength of the first radio signal 2 at a certain point in time corresponds to the position of the object 4 at the same point in time.

FIG. 6 schematically illustrates a diagram depicting different radio signals, which can be extracted from a radio basic signal 29. Specifically, the extractable radio signals according to FIG. 6 refer to a first radio signal 2 corresponding to a first time interval 5, a second time interval 18 corresponding to a second time interval 19 and a third radio signal 20 corresponding to a third time interval 21. In addition, further radio signals corresponding time intervals are also taken into consideration. Hereby, each of the time intervals 5, 19, 21 comprises a starting point 27 and an end point 28.

According to this, the first radio signal 2 and/or the second radio signal 18 and/or the third radio signal 20 may comprise the same data volume size or a different data volume size. Further, the first radio signal 2 and/or the second radio signal 18 and/or the third radio signal 20 may comprise the same time interval length or a different time interval length. Further, the first time interval 5 of the first radio signal 2 and/or the second time interval 19 of the second radio signal 18 and/or the third time interval 21 of third radio signal 20 does not comprise an overlap region. However, it may also be taken into consideration that at least two of the time intervals 5, 19, 21 comprises an overlap region. In addition, the distance in between the starting point 27 of the first time interval 5 and the second time interval 19 may be equal to the distance in between the starting point 27 of the second time interval 19 and the third time interval 21. However, it may also be taken into consideration that the distance in between the starting point 27 of the first time interval 5 and the second time interval 19 is different from the distance in between the starting point 27 of the second time interval 19 and the third time interval 21.

FIG. 7 schematically illustrates a flowchart of a method 100 of processing a first radio signal 2 according to various examples.

At 110, the first radio signals 2 may be received, wherein the first radio signal 2 is indicative of a first set of positions of an object 4 within a first time interval 5.

At 120, the transaction data 7 may be generated based on the received first radio signal 2.

At 130, the transaction data 7 may be transferred to the distributed database 9.

According to various examples, the above-outlined method 100 may be executed by any of the above outlined configurations of the data processing device 1.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A data processing device adapted to process a first radio signal, comprising:
a receiver unit adapted to receive the first radio signal, wherein the first radio signal indicative of a first set of positions of an object within a first time interval;
a transaction data generation unit adapted to generate first transaction data based on the received first radio signal; and
an output unit adapted to transfer the first transaction data to a distributed database.

2. The data processing device according to claim 1, further comprising an encryption unit, which is adapted to encrypt the first transaction data and to provide a corresponding transaction data key, wherein the output unit is further adapted to transfer the corresponding transaction data key to the distributed database.

3. The data processing device according to claim 2, wherein the output unit is adapted to transfer the corresponding transaction data key to the distributed database after a corresponding encrypted first transaction data has been transferred to the distribution database.

4. The data processing device according to claim 1, further comprising a hash value generation unit, which is adapted to generate a hash value of the first transaction data comprising a reduced data size, wherein the output unit is further adapted to transfer the hash value to the distributed database.

5. The data processing device according to claim 4, wherein the output unit is adapted to transfer the first transaction data to the distributed database after the hash value has been transferred to the distributed database.

6. The data processing device according to claim 1, wherein the output unit is adapted to transfer the first transaction data to the distributed database using wireless mobile communication.

7. The data processing device according to claim 1, wherein the first transaction data comprise first information related to a serial number of the data processing device and/or position, velocity, time (PVT) information determined by the data processing device.

8. The data processing device according to claim 1, wherein the first transaction data comprise second information indicative of at least one further property of the object, wherein the at least one further property relates to temperature, pressure, brightness data, image information, video information, radar information, and lidar information.

9. The data processing device according to claim 1, wherein the distributed database is a Blockchain based database.

10. The data processing device according to claim 9, wherein the first transaction data comprise a Smart Contract program code.

11. The data processing device according to claim 1, further adapted to process a second radio signal indicative of a second set of positions of the object with in a second time interval, wherein the transaction data generation unit further adapted to generate second transaction data based on the received second radio signal, further wherein the output unit is adapted to transfer the first transaction data and the second transaction data separately to the distributed database.

12. The data processing device according to claim 11, wherein the first radio signal and the second radio signal comprise a same data volume size and/or same time interval length.

13. The data processing device according to claim 11, further adapted to process a second radio signal indicative of a second set of positions of the object within a second time interval, wherein the first time interval and the second time interval do not comprise an overlap region.

14. The data processing device according to claim 11, further adapted to process a third radio signal indicative of a third set of positions of the object within a third time interval, wherein a distance in between a starting point of the first time interval and the second time interval is equal to a distance in between a starting point of the second time interval and the third time interval.

15. The data processing device according to claim 1, wherein the first radio signal is based on a satellite navigation service.

16. A transaction data receiving device, which is adapted to be in communication with the data processing device according to claim 1, and which is adapted to receive the first transaction data of the data processing device in case that the transaction data receiving device forms an integral part of the distributed database.

17. A method of processing a first radio signal, the method comprising:
receiving the first radio signal, wherein the first radio signal is indicative of a first set of positions of an object within a first time interval;
generating transaction data Abased on the received first radio signal; and
transferring the transaction data to the distributed database.

18. The method according to claim 17, which is executed by a data processing device.
